(19) United States
(12) Patent Application Publication
(10) Pub. No.: US 2015/0202848 A1
(43) Pub. Date: Jul. 23, 2015

(54) DISPLAY DEVICE

(71) Applicant: Samsung Display Co., Ltd., Yongin-City (KR)

(72) Inventors: Jong Hwan CHO, Ansan-si (KR); Hyeon Deuk HWANG, Cheonan-si (KR); Jongdeok PARK, Seoul (KR)

(21) Appl. No.: 14/601,590

(22) Filed: Jan. 21, 2015

(30) Foreign Application Priority Data
Jan. 22, 2014 (KR) 10-2014-0007842

(51) Int. Cl. B32B 27/20; B32B 17/00; B32B 7/12

(52) U.S. Cl. CPC B32B 27/20; B32B 7/12; B32B 17/00; B32B 2307/412; B32B 2457/20

(57) ABSTRACT

A display device includes a display panel displaying an image and a window member including a base member including a display region through which the image is transmitted and a non-display region through which the image is not transmitted and a decorative layer which is disposed in correspondence to the non-display region and includes a base material and microcapsules dispersed in the base material and having respective predetermined colors.

This U.S. non-provisional patent application claims priority to Korean Patent Application No. 10-2014-0007842, filed on Jan. 22, 2014, and all the benefits accruing therefrom under 35 U.S.C. §119, the entire contents of which are hereby incorporated by reference.

### BACKGROUND

1. Field

The invention herein relates to a display device, and more particularly, to a display device providing a predetermined decorative pattern.

2. Description of the Related Art

Various display devices which are used in multimedia devices such as TVs, mobile phones, navigation devices, computer monitors, game consoles and the like are being developed. The display devices provide a user with images having predetermined information. The display devices generally include a region (a display region) on which the images are displayed and a region (a non-display region) on which the images are not displayed. The non-display region is perceived to the user as a boundary having a solid color.

### SUMMARY

The invention provides a display device providing a decorative pattern on a non-display region.

Exemplary embodiments of the invention provide display devices include a display panel displaying an image and a window member. The window member may include a base member and a decorative layer. The base member may include a display region through which the image is transmitted and a non-display region through which the image is not transmitted. The decorative layer disposed in correspondence to the non-display region and including a base material and microcapsules dispersed in the base material and having respective predetermined colors.

In exemplary embodiments, the respective microcapsules may include a core having the predetermined color and a shell surrounding the core. The core may include a pigment or a dye. The shell may include silicon oxide or titanium oxide. The shell may include at least any one or more selected from urethane, acrylic, and an epoxy.

In exemplary embodiments, the base material may include a transparent plastic resin. The base material may further include a pigment or a dye. The microcapsules may include first microcapsules having a first color, and the pigment or the dye has a second color different from the first color. The microcapsules may further include second microcapsules having a third color different from the first and second colors.

In exemplary embodiments, the window member may further include a color layer disposed on the decorative layer to correspond to the non-display region.

In exemplary embodiments, the window member may include a first member, a second member, and an adhesive layer bonding the first member to the second member. The decorative layer may be disposed on one surface of the second member that the adhesive layer does not contact.

In exemplary embodiments, the window member may further include a base member, a plastic film and an adhesive layer bonding the base member to the plastic film. The decorative layer may be disposed on one surface of the plastic film which the adhesive layer contacts.

In exemplary embodiments, the color layer may be disposed between the decorative layer and the one surface of the plastic film.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain principles of the invention. In the drawings:

FIG. 1 is a perspective view of an exemplary embodiment of a display device according to the invention;

FIG. 2 is an exploded perspective view of the display device illustrated in FIG. 1;

FIG. 3 is a block diagram of the display device illustrated in FIG. 1;

FIG. 4 is a cross-sectional view of a window member, which is taken along line I-I′ of FIG. 1;

FIG. 5 is an enlarged view of a part of FIG. 4;

FIGS. 6A to 6C are enlarged views of a microcapsule; and

FIGS. 7 to 10 are cross-sectional views of an exemplary embodiment of a window member according to the invention.

### DETAILED DESCRIPTION

The invention may be variously modified and realized in various forms, and thus specific embodiments will be exemplified in the drawings and described in detail hereinbelow. However, the invention is not limited to the specific disclosed forms, and needs to be construed to include all modifications, equivalents, or replacements included in the spirit and technical range of the invention.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, an exemplary embodiment of the invention will be described in detail with reference to the accompanying drawings.

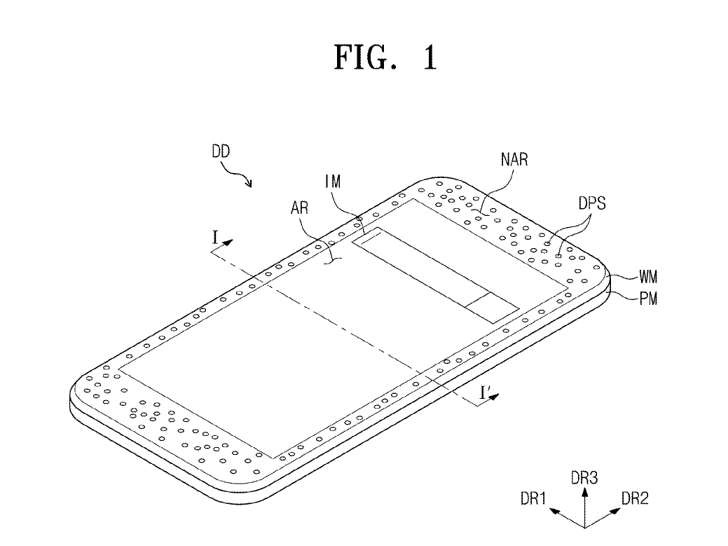

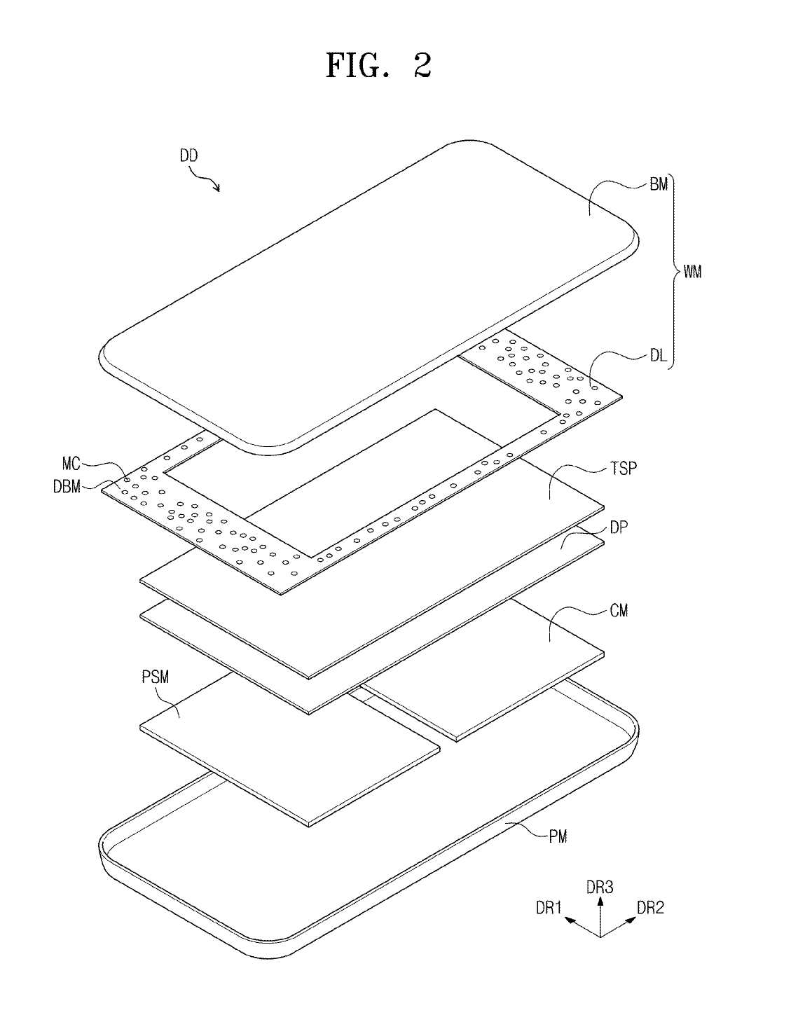

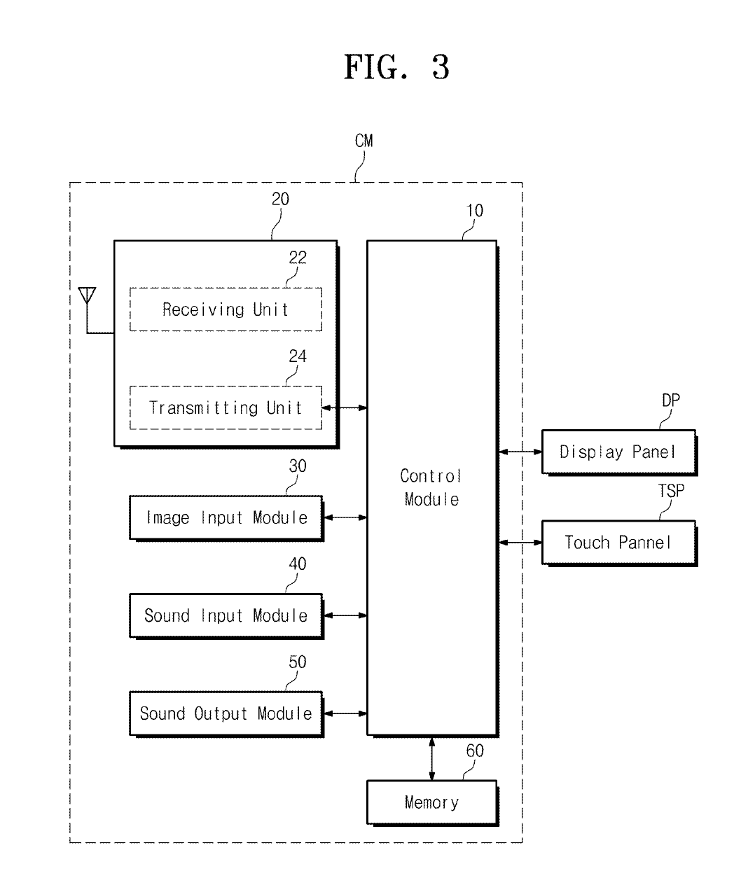

FIG. 1 is a perspective view of a display device according to an exemplary embodiment of the invention. FIG. 2 is an exploded perspective view of the display device illustrated in FIG. 1. FIG. 3 is a block diagram of the display device illustrated in FIG. 1. Even though a mobile phone is exemplarily illustrated in FIGS. 1 to 3, a display device according to the invention is not limited hereto and may be modified to various information providing devices including a TV, a navigation device, a computer monitor, and a game console.

As illustrated in FIG. 1, a display device DD includes a plurality of regions divided on a front surface. The front surface of the display device DD is a surface on which an image IM is displayed, and may be defined by first and second directions DR1 and DR2 orthogonal to each other. The display device DD may further include a window member WM and a protection unit PM.

The display device DD includes a display region AR on which the image IM is displayed and a non-display region NAR adjacent to the display region. FIG. 1 illustrates an internet search window as an example of the image IM. The non-display region NAR provides a decorative pattern DPS on the front surface. As illustrated in FIG. 1, the decorative pattern may be a water drop pattern, for example.

As an example, the display region AR may have a quadrangle shape. The non-display region NAR surrounds the display region AR. In other words, the non-display region NAR forms the boundary of the front surface of the display device DD. Furthermore, the shape of the non-display region NAR may be modified in the exemplary embodiment. In an exemplary embodiment, the non-display region NAR may not form the boundary. In another exemplary embodiment, parts of the non-display region NAR facing each other in the first direction DR1 in FIG. 1 may be omitted.

As illustrated in FIG. 2, a display device DD according to an exemplary embodiment of the invention includes a window member WM, a display panel DP, a touch panel TSP, a power source unit PSM, a circuit unit CM, and a protection unit PM. The window member WM and the touch panel TSP, and the display panel DP may be stacked in a thickness direction DR3. An adhesive layer is not shown in FIG. 2. In an exemplary embodiment, light transparent adhesive layers may be disposed between the window member WM and the display panel DP and between the touch panel TSP and the window member WM, respectively, for example.

The window member WM includes a base member BM and a decorative layer DL. In an exemplary embodiment, the base member BM is a transparent member and may include a glass substrate or a plastic substrate, for example. In another exemplary embodiment, the base member BM may include a tempered glass substrate or a reinforced plastic substrate, for example. In another exemplary embodiment, the base member BM may include a flexible plastic substrate, for example. In an exemplary embodiment, the base member may have a multilayer structure.

The decorative layer DL is disposed on one surface of the base member BM (the bottom surface of the base member BM in FIG. 2). The non-display region NAR illustrated in FIG. 1 is defined as a region in which the decorative layer DL is substantially disposed. In an exemplary embodiment, the decorative layer DL includes at least one of a base material DBM and microcapsules MC dispersed therein. The microcapsules MC form the decorative pattern DPS illustrated in FIG. 1. The decorative layer DL will be further described later.

The touch panel TSP calculates coordinate information of an external input. In exemplary embodiments, the external input may refer to an input with a stylus pen, or a user's finger, or the like. Substantially, the external input occurs on the window member WM. In an exemplary embodiment, the touch panel TSP may employ a resistive touch panel, a capacitive touch panel, or an electromagnetic-induction touch panel, for example.

In an exemplary embodiment, the touch panel TSP includes at least one substrate, an insulation layer, and a plurality of conductive layers. In an exemplary embodiment, the touch panel TSP and the display panel DP manufactured in separate processes may be coupled through the light transparent adhesive layer. In an exemplary embodiment of the invention, the touch panel TSP may be directly disposed on the display panel DP. In an exemplary embodiment, any one of the plurality of conductive layers may be directly disposed on one surface of the display panel DP (the top surface of the display panel DP in FIG. 2), for example. However, the invention is not limited thereto, and the touch panel TSP may be omitted in another exemplary embodiment of the invention.

The display panel DP creates the image IM. In an exemplary embodiment, the display panel DP may include, for example, an organic light emitting display panel, a liquid crystal display panel, a plasma display panel, an electrophoretic display panel, an electrowetting display panel, or the like. However, the invention is not limited thereto, and the display panel DP may include various other panels.

The protection member PM accommodates the display panel DP, the touch panel TSP, the power supply unit PSM, and the circuit unit CM. The protection member PM may be coupled to the window member WM. FIG. 2 exemplarily illustrates the protection member PM including one member, but the invention is not limited thereto, and the protection member PM may include two or more parts coupled to each other.

The power source unit PSM provides power necessary for driving the display device DD. The power supply unit PSM may provide driving voltages to the display panel DP and the touch panel TSP. The circuit unit CM includes a circuit substrate and electronic modules connected to the circuit substrate. The circuit substrate includes a plurality of insulation layers and a plurality of wiring layers. A part of the electronic modules is mounted on the circuit substrate and another part may be connected to the circuit substrate through a flexible circuit substrate.

The electronic modules are described in detail with reference to FIG. 3. As illustrated in FIG. 3, the electronic modules may include a control module 10, a wireless communication module 20, an image input module 30, a sound input module 40, a sound output module 50 and a memory 60.

The control module 10 controls an overall operation of the display device DD. In an exemplary embodiment, the control module 10 activates or deactivates the display panel DP and the touch panel TSP, for example. The control module 10 may control the display panel DP, the image input module 30, the sound input module 40, and the sound output module 50 on the basis of a touch signal received from the touch panel TSP.

The wireless communication module 20 may transmit/receive a wireless signal to/from another terminal by using a Bluetooth or wi-fi line, for example. The wireless communication module 20 may transmit/receive a voice signal by using a general communication line. The wireless communication module 20 includes a transmitting unit 24 modulating a signal to be transmitted to transmit the modulated signal, and a receiving unit 22 demodulating a received signal.

The image input module 30 processes an image signal to transform the processed signal to image data inputtable to the display panel DP. The sound input module 40 receives an external sound signal through a microphone in a recording mode or a voice recognition mode and transforms the received signal into electric sound data, for example. The sound output module 50 transforms sound data received from the wireless communication module 20 or sound data stored in the memory 60, and outputs the transformed sound data.

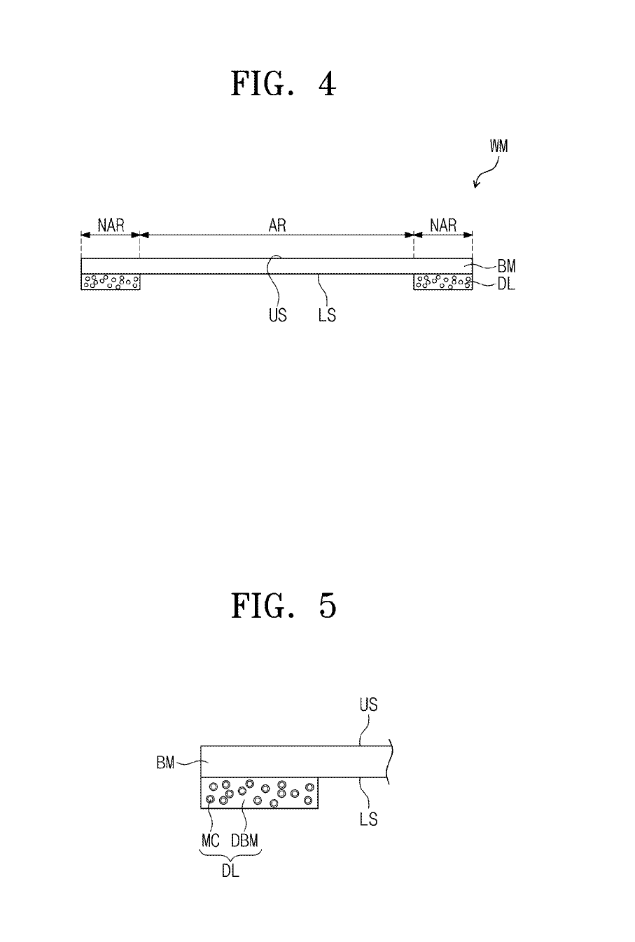

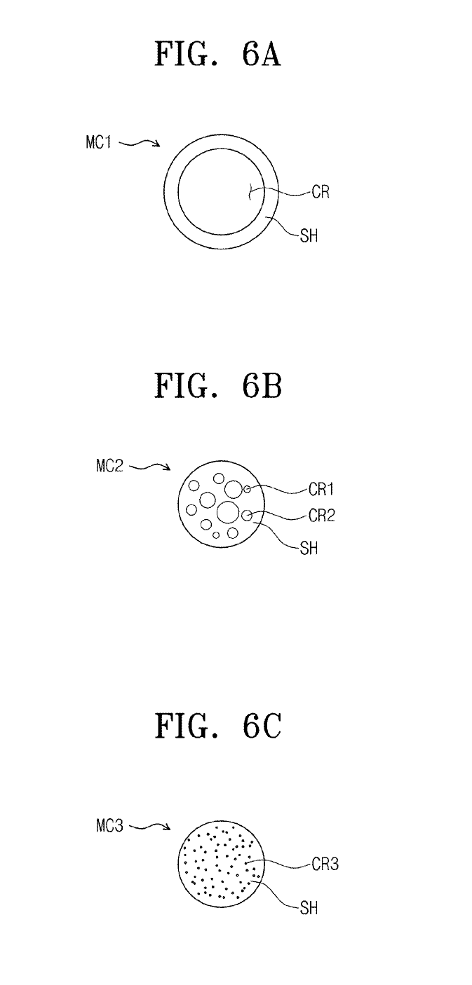

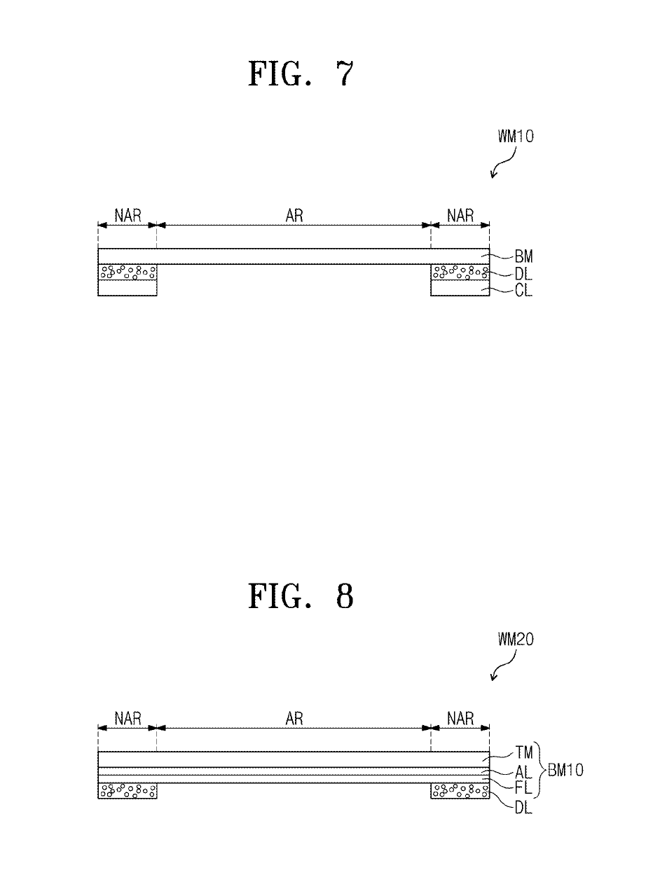

FIG. 4 is a cross-sectional view of a window member, which is taken along line IT of FIG. 1. FIG. 5 is an enlarged view of a part of FIG. 4. FIGS. 6A to 6C are enlarged views of a microcapsule. The decorative layer DL is described in detail with reference to FIGS. 4 to 6C.

As illustrated in FIGS. 4 and 5, the decorative layer DL is disposed on the bottom surface LS of the base member BM. The decorative layer DL is overlapped with the non-display region NAR and not overlapped with the display region AR. In an exemplary embodiment, the decorative layer DL may be directly disposed on the bottom surface LS of the base member BM. In another exemplary embodiment of the invention, the decorative layer DL may be disposed on a buffer layer (not shown) disposed on the bottom surface LS of the base member BM.

The decorative layer DL includes a base material DBM and microcapsules MC. The microcapsules MC are dispersed in the base material DBM. In an exemplary embodiment, the decorative layer DL may include the microcapsules in a range of about 0.5 wt % to about 50 wt % with respect to the base material DBM, for example.

In an exemplary embodiment, the decorative layer DL may be provided with a printing method or a coating method, for example. In an exemplary embodiment, a base material solution having the microcapsules MC dispersed therein is printed only on the non-display region NAR and dried. The base material solution having the microcapsules MS dispersed therein is coated on the bottom surface LS of the base member BM and dried to form a coating layer, and a decorative layer DL may be provided by removing a part of the coating layer corresponding to the display region AR, that is, according to photolithography.

In an exemplary embodiment, the base material DBM includes a transparent plastic resin, for example. The transparent plastic resin may include polymethylmethacrylate, polycarbonate, polyvinyl chloride, polystyrene, and the like. In an exemplary embodiment, the base material DBM may further include additives such as a light curable resin and a dispersing agent.

The microcapsules MC have predetermined colors. In an exemplary embodiment, a portion of the microcapsules MC may have a red color, another portion may have a green color, and still another portion may have a blue color, for example. In another exemplary embodiment, the microcapsules MC may have the same color, for example, a black color or a white color. The color of the microcapsules MC is not limited. The microcapsules MC is perceived to a user as a decorative pattern having predetermined color on the top surface US of the base member BM.

The base material DBM may further include a pigment or a dye having a predetermined color. The pigment or dye included in the base material DBM may have a different color from those of the microcapsules. In an exemplary embodiment, the pigment or dye included in the base material DBM may have a white color and the microcapsules MC may have a red color, for example. Accordingly, the decorative layer DL is perceived as a red water drop pattern in the white color background.

The base material DBM further includes the pigment or dye to allow the decorative layer DL to have a function of a light shielding layer for reducing/shielding external light. Accordingly, an internal configuration or internal element that is overlapped with the non-display region NAR (see FIG. 1) in the display device DD (see FIG. 1) is not perceived by the user. In an exemplary embodiment, the pigment or dye may have a black color to improve light reducing/shielding efficiency.

FIG. 6A exemplarily illustrates a mononuclear microcapsule. The mononuclear microcapsule MC1 includes a core CR having a predetermined color and a shell SH surrounding the core CR. The core CR includes a pigment or a dye.

In an exemplary embodiment, the pigment may include a metal oxide, for example. In an exemplary embodiment, the metal oxide may include iron oxide or titanium oxide, for example. In an exemplary embodiment, the pigment may further include ferrocyanide, for example. In an exemplary embodiment, the dye may include an organic dye having a predetermined color, for example.

In an exemplary embodiment, the shell SH may include an inorganic material such as silicon oxide or an organic material such as melamine, urethane, acrylic, or an epoxy. In an exemplary embodiment, the shell SH may further include proteins, lipids and the like.

FIG. 6B exemplarily illustrates a polynuclear microcapsule. The polynuclear microcapsule MC2 includes heterogeneous cores CR1 and CR2. The polynuclear microcapsule displays a mixed color of the cores CR1 and CR2.

FIG. 6C exemplarily illustrates a matrix microcapsule. The matrix microcapsule MC3 includes a plurality of cores CR3 dispersed in the shell SH.

In an exemplary embodiment, the microcapsules illustrated in FIGS. 6A to 6C may have a diameter from about 0.5 micrometer (μm) to about 100 μm. The microcapsules may be manufactured by a known interfacial polycondensation method, orifice method, coacervation method, double emulsion method, or rapid expansion of supercritical fluids (“RESS”) method.

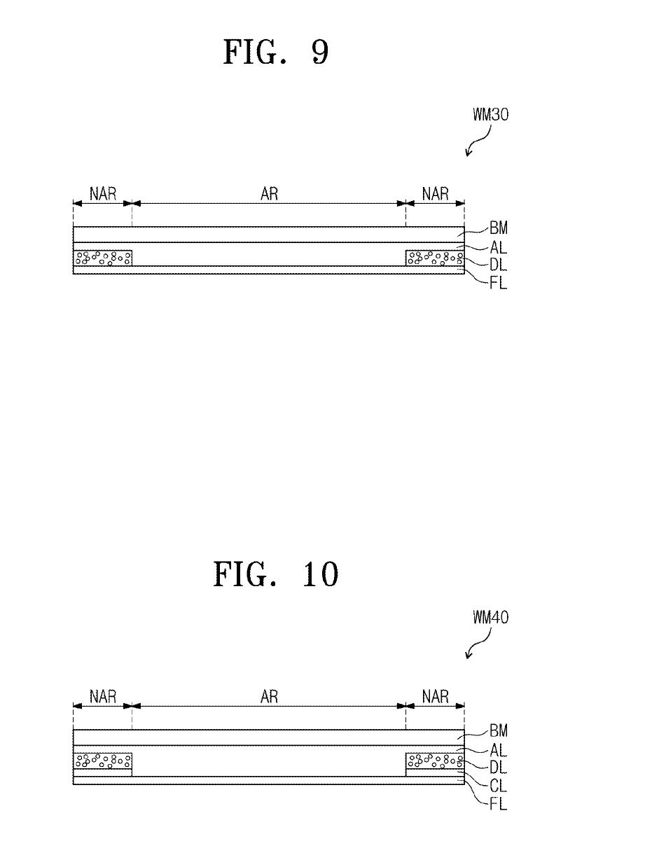

FIGS. 7 to 10 are cross-sectional views of a window member according to an exemplary embodiment of the invention. FIGS. 7 to 10 illustrate cross-sections corresponding to FIG. 4. Hereinafter, description about the substantially same configuration as that described in relation to FIGS. 1 to 6C may be omitted.

As illustrated in FIG. 7, a window member WM10 includes a base member BM, a decorative layer DL, and a color layer CL. The color layer CL is disposed on the decorative layer DL to correspond to the non-display region NAR.

The decorative layer DL includes a transparent base material DBM (see FIG. 5) and microcapsules MC (see FIG. 5) dispersed therein. In an exemplary embodiment, in order to raise transparency, the base material DBM may not include a pigment or a dye.

The color layer has a predetermined color. In an exemplary embodiment, the color layer CL includes a plastic resin and a pigment or a dye, for example. In an exemplary embodiment, the color layer CL may further include additives such as a light curable resin and a dispersing agent. In an exemplary embodiment, the color layer CL may be provided with the same method as that for the decorative layer DL.

The color layer CL has a different color from that of the microcapsules MC. In an exemplary embodiment, the color layer CL may have, for example, a white color, and the microcapsules MC may have, for example, a red color. Accordingly, the user may perceive a red water drop pattern in the white color background on the window member WM10.

The color layer CL may have a function of a light shielding layer for reducing/shielding external light. Accordingly, an internal configuration that is overlapped with the non-display region NAR (see FIG. 1) in the display device DD (see FIG. 1) is not perceived by the user.

As illustrated in FIG. 8, a window member WM20 includes a base member BM10 having a multilayer structure. The base member BM10 having the multilayer structure includes a first member TM, a second member FL and an adhesive layer AL bonding the first member TM to the second member FL.

In an exemplary embodiment, the first member TM may be a tempered glass or reinforced plastics having a high hardness. In an exemplary embodiment, the second member FL may be a plastic film, for example. In an exemplary embodiment, the adhesive layer AL may include a light transparent adhesive, for example. The decorative layer DL may be disposed on one surface of the second member FL, which is not contacted by the adhesive layer AL. The decorative layer DL is disposed on the one surface of the second member FL and the first member TM may be bonded to the second member FL. Although not illustrated in the drawing, the window member WM20 may further include the color layer CL (see FIG. 7).

As illustrated in FIG. 9, the window member WM30 includes a base member BM, an adhesive layer AL, a decorative layer DL, and a plastic film FL. The decorative layer DL is disposed on one surface of the plastic film FL. The adhesive layer AL bonds one surface of the base member BM to the one surface of the plastic film FL on which the decorative layer DL is disposed.

The decorative layer DL is disposed on the one surface of the plastic film FL, and the one surface of the base member BM may be bonded to the one surface of the plastic film FL on which the decorative layer DL is disposed.

As illustrated in FIG. 10, a window member WM40 may further include a color layer CL on the window member WM30 illustrated in FIG. 9. The color layer CL may be disposed on one surface of the plastic film FL that the adhesive layer AL contacts. The color layer CL is disposed between the one surface of the plastic film FL and the decorative layer DL. That is, the color layer CL may be interposed between the plastic film FL and the decorative layer DL.

The color layer CL and the decorative layer DL are disposed on the one surface of the plastic film FL, and the one surface of the base member BM may be bonded to the one surface of the plastic film FL.

According to an exemplary embodiment of the invention, a non-display region of a display device provides a user with a decorative pattern. Microcapsules overlapping the non-display region provide a water drop pattern. The microcapsules can include first and second microcapsules having different colors. Accordingly, various water drop patterns can be provided.

A decorative layer including the microcapsules can have a function of a light shielding layer for reducing/shielding external light. The external light can be shielded with the color layer.

The above-disclosed subject matter is to be considered illustrative and not restrictive, and the appended claims are intended to cover all such modifications, enhancements, and other exemplary embodiments, which fall within the true spirit and scope of the invention. Thus, to the maximum extent allowed by law, the scope of the invention is to be determined by the broadest permissible interpretation of the following claims and their equivalents, and shall not be restricted or limited by the foregoing detailed description.

What is claimed is:

1. A display device comprising:
a display panel configured to display an image and
a window member which is disposed on the display panel and comprises:
a base member in which a display region through which the image is transmitted and a non-display region through which the image is not transmitted are defined; and
a decorative layer disposed in correspondence to the non-display region and including a base material and microcapsules dispersed in the base material and respectively having predetermined colors

2. The display device of claim 1, wherein the microcapsules respectively comprise,
a core having the predetermined color; and
a shell surrounding the core.

3. The display device of claim 2, wherein the core comprises at least one of a pigment and a dye.

4. The display device of claim 2, wherein the shell comprises at least one of silicon oxide and titanium oxide.

5. The display device of claim 2, wherein the shell comprises at least one of urethane, acrylic, and an epoxy.

6. The display device of claim 1, wherein the base material comprises a transparent plastic resin.

7. The display device of claim 6, wherein the base material further comprises at least one of a pigment and a dye.

8. The display device of claim 7, wherein the microcapsules comprise first microcapsules having a first color, and
the at least one of the pigment and the dye has a second color different from the first color.

9. The display device of claim 8, wherein the microcapsules further comprise second microcapsules having a third color different from the first and second colors.

10. The display device of claim 6, further comprising a color layer disposed on the decorative layer to correspond to the non-display region.

11. The display device of claim 10, wherein the microcapsules comprise first microcapsules having a first color, and
the color layer has a second color different from the first color.

12. The display device of claim 11, wherein the microcapsules further comprise second microcapsules having a third color different from the first and second colors.

13. The display device of claim 1, wherein the base member comprises a first member, a second member, and an adhesive layer bonding the first member to the second member, and
the decorative layer is disposed on one surface of the second member which the adhesive layer does not contact.

14. The display device of claim 13, wherein the first member includes at least one of tempered glass and reinforced plastics.

15. The display device of claim 14, wherein the second member includes a plastic film.

16. The display device of claim 1, wherein the window member further comprises a plastic film and an adhesive layer bonding the base member to the plastic film, and
the decorative layer is disposed on one surface of the plastic film which the adhesive layer contacts.

17. The display device of claim 16, further comprising a color layer disposed between the decorative layer and the one surface of the plastic film.

18. The display device of claim 17, wherein the base material comprises a transparent plastic resin,
the microcapsules comprise first microcapsules having a first color, and
the color layer has a second color different from the first color.

19. The display device of claim 1, further comprising a touch panel disposed between the window member and the display panel.

20. The display device of claim 19, further comprising a protecting member which is coupled to the window member and accommodates the display panel and the touch panel.
